(19) United States
(12) Patent Application Publication
(10) Pub. No.: US 2026/0036140 A1
(43) Pub. Date: Feb. 5, 2026

(54) FAN PROTECTIVE SHELL STRUCTURE AND A CEILING FAN

(71) Applicant: Jing HU, Bengbu City (CN)

(72) Inventor: Jing HU, Bengbu City (CN)

(73) Assignee: Zhongshan Qiangjing Lighting Appliance Co., Ltd., Zhongshan City (CN)

(21) Appl. No.: 19/353,642

(22) Filed: Oct. 9, 2025

(30) Foreign Application Priority Data
Oct. 15, 2024 (CN) 202422500840.6

(51) Int. Cl. F04D 29/52; F04D 25/08; F21V 33/00

(52) U.S. Cl. CPC F04D 29/522; F04D 25/088; F21V 33/0096

(57) ABSTRACT

The present disclosure discloses a fan protective shell structure, including a connecting assembly and at least three protective units, in which the protective units are detachably connected to the connecting assembly, and the protective units are spaced apart from each other. The disclosure also discloses a ceiling fan using the fan protective shell structure, including a motor, with the fan protective shell structure surrounding the motor, and the lower end of the fan body further includes a light. While providing protection for the motor, this design allows for the individual replacement of damaged parts, effectively reducing costs.

### CROSS-REFERENCE TO RELATED APPLICATIONS

This application claims priorities to Chinese Patent Application No. 202422500840.6, filed on 15th, October 2024, both of which are hereby incorporated by reference in their entireties.

### TECHNICAL FIELD

The present disclosure relates to the technical field of ceiling fan structures, particularly to a fan protective shell structure and a ceiling fan.

### BACKGROUND OF THE INVENTION

Ceiling fans, as devices for cooling and air circulation, are widely used in daily life. Therefore, the protection of the motor, as the core component of a ceiling fan, is particularly important. Currently, the primary method of motor protection in ceiling fans on the market is to add an integrated protective shell around the motor body. Although this method protects the motor, it has the drawback that if the integrated protective shell is damaged, the entire shell must be replaced, which is costly. To address this issue, the present disclosure provides a fan protective shell structure and ceiling fan that can effectively solve the above problems. This design allows for the protection of the motor while enabling individual replacement of the damaged parts. Additionally, the appropriate spacing between each protective unit not only maintains the protection effect but also effectively reduces costs without compromising performance.

### SUMMARY OF THE INVENTION

To overcome the shortcomings of the prior art, the present disclosure provides a fan protective shell structure and a ceiling fan that, while protecting the motor, allows for the individual replacement of damaged parts. Additionally, the design incorporates appropriate spacing between each protective unit, which effectively reduces costs without compromising the protection effect.

A fan protective shell structure, in which the fan protective shell structure is arranged around the motor to provide protection for the motor, in which it includes:

A connecting assembly and at least three protective units, in which the protective units are detachably connected to the connecting assembly, and the protective units are spaced apart from each other.

Furthermore, the connecting assembly includes a connector, a first fastener, and a limiting member. The protective units are connected by the connector, with the first fastener securing the protective units to the connector. The limiting member is positioned between two adjacent protective units to define the distance between them.

Furthermore, the protective units are provided with connection holes, into which the connector is inserted. The connector has a cavity that is open at both ends, and the first fastener is inserted into the cavity to abut against the protective unit.

Furthermore, at least one limiting member is provided between adjacent protective units, with the limiting member being fitted onto the connector and coaxially aligned with the connector.

Furthermore, the protective unit at the topmost position extends inward to form a hanging cover portion, which is used for connection to a through rod.

Furthermore, the fan protective shell structure also includes a hanging base, which includes a fixed portion, a connecting portion, and a second fastener. The hanging cover portion is fixedly connected to the connecting portion using the second fastener, and the fixed portion is used to connect the through rod.

Furthermore, the connecting portion has a first through hole, and the hanging cover portion has a corresponding second through hole. The second fastener is inserted into both the first through hole and the second through hole.

Furthermore, the fan protective shell structure also includes a snap-fit member and a protective cover. The protective cover is snap-fitted to the snap-fit member, which is used to connect to the through rod. The protective cover and the hanging cover portion together form an accommodating space, within which the fixed portion is located.

Furthermore, the hanging cover portion has a first linkage hole, and the protective cover has a second linkage hole. The first linkage hole and the second linkage hole are designed to allow the through rod to be inserted.

A ceiling fan, including a motor and the fan protective shell structure according to any of the technical solutions described above, in which the fan protective shell structure is arranged around the motor, and the lower end of the fan body is also provided with a light.

The beneficial effects of the present disclosure are: by configuring the structure as described above, when the protective shell component is damaged, the damaged protective units can be individually replaced. Additionally, by providing appropriate spacing between each protective unit, the cost is effectively reduced without compromising the protection effect.

### BRIEF DESCRIPTION OF THE DRAWINGS

To better illustrate the technical solutions in the embodiments of the present application, a brief introduction to the accompanying drawings used in the description of the embodiments will be provided below. The drawings described below are merely some of the embodiments of the present application. For those skilled in the art, without inventive effort, other drawings can be derived from these.

The present application will be further described in conjunction with the accompanying drawings and embodiments.

FIG. 1 illustrates a partial schematic view of the ceiling fan from one angle.

FIG. 2 illustrates a partial schematic view of the ceiling fan from another angle.

FIG. 3 illustrates an exploded view of a partial structure of the ceiling fan.

FIG. 4 illustrates another exploded view of a partial structure of the ceiling fan.

FIG. 5 illustrates a partial cross-sectional view of the ceiling fan.

FIG. 6 illustrates a complete structural view of the ceiling fan from one angle.

The reference numerals used in the drawings are explained in detail as follows:

2. Fan protective shell structure; 22. Connecting assembly; 21. Protective unit; 221. Connector; 222. First fastener; 223. Limiting member; 221a. Cavity; 211. Connection hole; 23. Hanging cover portion; 24. Hanging base; 241. Fixed portion; 242. Connecting portion; 243. Second fastener; 242a. First through hole; 232a. Second through hole; 25. Snap-fit member; 26. Protective cover; 231. First linkage hole; 261. Second linkage hole; 1. Motor; 11. Light.

### DESCRIPTION OF EMBODIMENTS

To make the objectives, features, and advantages of the present application clearer and easier to understand, the following detailed description of the specific embodiments of the present application is provided in conjunction with the accompanying drawings. The description below includes many specific details to facilitate a full understanding of the application. However, the application can be implemented in many different ways other than those described here, and those skilled in the art can make similar modifications without departing from the scope of the application. Therefore, the application is not limited to the specific embodiments disclosed below.

In the description of the present application, it should be understood that terms such as “center,” “longitudinal,” “lateral,” “length,” “width,” “thickness,” “up,” “down,” “front,” “back,” “left,” “right,” “vertical,” “horizontal,” “top,” “bottom,” “inside,” “outside,” “clockwise,” “counterclockwise,” “axial,” “radial,” “circumferential,” etc., refer to positional or directional relationships based on the orientations or positions shown in the drawings, for the purpose of simplifying the description and not implying that the device or component must have a specific orientation or configuration. Therefore, these terms should not be interpreted as limiting the application.

Additionally, terms such as “first,” “second,” and similar terms are used solely for descriptive purposes and should not be understood to imply any relative importance or to indicate the quantity of the technical features being referred to. The features denoted by “first,” “second,” etc., may explicitly or implicitly include at least one of the features. In the description of the present application, the term “plurality” means at least two, such as two, three, and so on, unless otherwise explicitly stated.

In the present application, unless otherwise clearly specified and limited, terms such as “install,” “connect,” “link,” “fix,” etc., should be understood in a broad sense. For example, it can refer to fixed connections, detachable connections, or integrated forms; it can refer to mechanical or electrical connections; it can refer to direct connections or indirect connections through intermediate media; it can also refer to internal communication between two components or mutual interaction between two components, unless otherwise explicitly specified. For those skilled in the art, the specific meaning of these terms in the application can be understood based on the context.

In the present application, unless otherwise clearly specified and limited, when the description uses terms such as “on” or “under” in reference to the relationship between the first feature and the second feature, it can mean that the first feature is in direct contact with the second feature or is indirectly in contact through an intermediate medium. Also, “above,” “on top of,” or “over” the second feature means that the first feature is directly or obliquely above the second feature, or merely indicates that the first feature is at a higher horizontal level than the second feature. Similarly, “below,” “under,” or “beneath” the second feature can mean that the first feature is directly or obliquely below the second feature or merely indicates that the first feature is at a lower horizontal level than the second feature.

It should be noted that if a component is said to be “fixed to” or “set on” another component, it can be directly on the other component or may be placed in a centered position. If a component is considered to be “connected” to another component, it may be directly connected to the other component or may have an intermediate component in between. The terms “vertical,” “horizontal,” “up,” “down,” “left,” “right,” and similar expressions used in the application are only for illustrative purposes and do not imply a unique method of implementation.

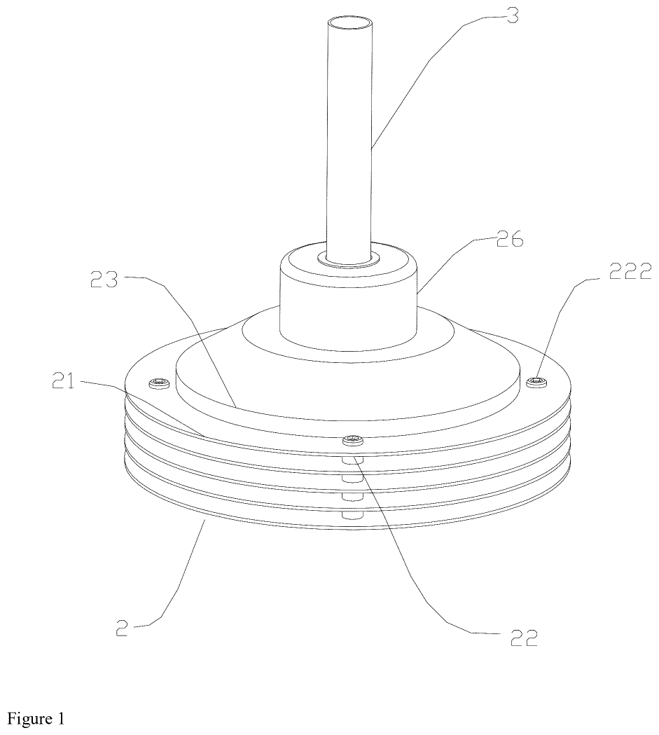

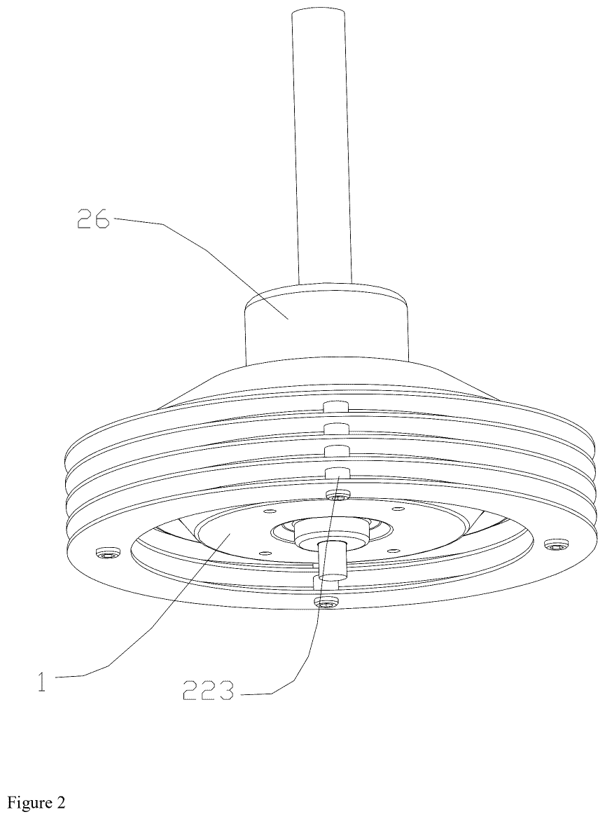

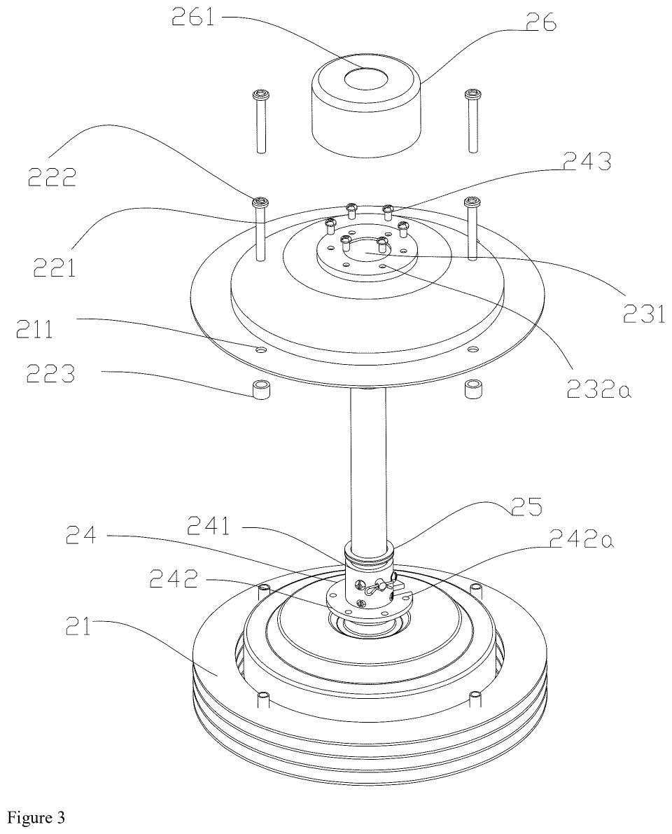

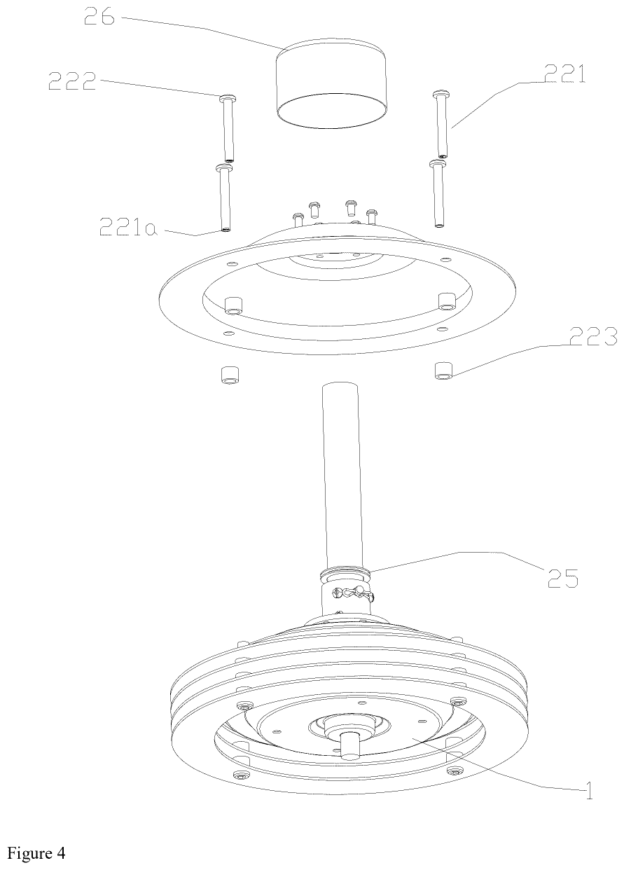

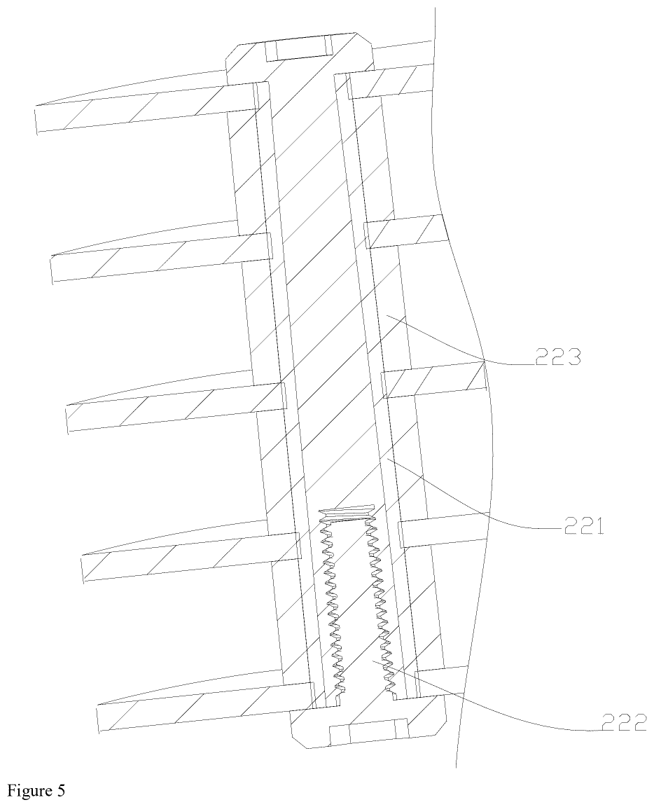

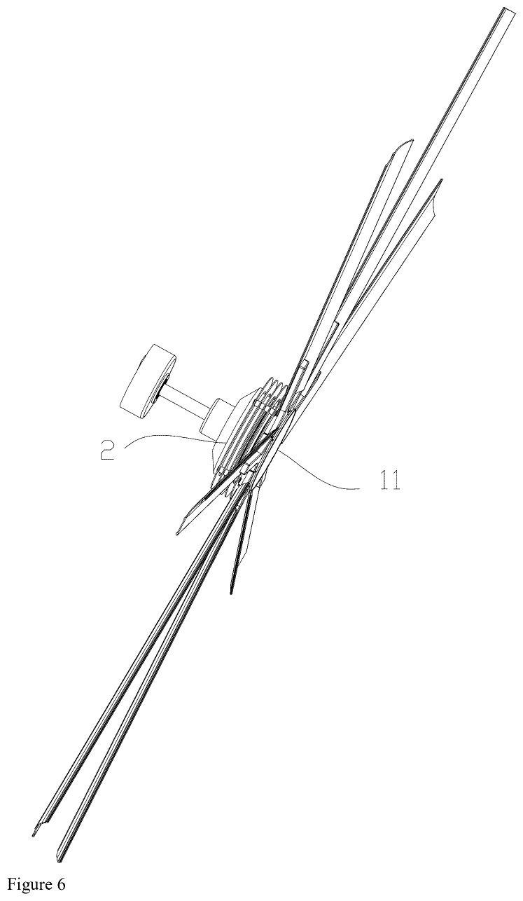

Referring to FIGS. 1 to 6, a fan protective shell structure surrounds the motor 1 to provide protection for the motor, including:

A connecting assembly 22 and at least three protective units 21, in which the protective units 21 are detachably connected to the connecting assembly 22, and the protective units 21 are spaced apart from each other.

With the configuration described above, when the fan protective shell structure 2 is damaged, the damaged protective unit 21 can be individually replaced, and the appropriate spacing between each protective unit 21 allows for cost reduction without compromising the protection effect.

In this embodiment, the connecting assembly 22 includes a connector 221, a first fastener 222, and a limiting member 223. The protective units 21 are connected via the connector 221, and the first fastener 222 secures the protective units 21 to the connector 221. The limiting member 223 is positioned between two adjacent protective units 21 to define the distance between them.

With the structure described above, when the damaged protective unit 21 needs to be replaced, the person replacing it can remove the first fastener 222, directly detach the damaged protective unit 21 from the connector 221, and when reinstalling, place the limiting member 223 between the adjacent protective units 21 to abut against them, ensuring the correct distance between the protective units 21. This simplifies the replacement process.

In this embodiment, the protective unit 21 is provided with a connection hole 211, into which the connector 221 is inserted. The connector 221 has a cavity 221a that communicates through both ends. The first fastener 222 is inserted into the cavity 221a and abuts against the protective unit 21.

With the structure described above, when the person replacing the damaged protective unit 21, they only need to pull out the first fastener 222 to directly detach the damaged protective unit 21 from the connector 221, making the replacement operation more convenient. Additionally, the cavity 221a allows for easier removal of the first fastener 222 by simple manipulation, making the process less physically demanding.

In this embodiment, at least one limiting member 223 is provided between adjacent protective units 21. The limiting member 223 is fitted onto the connector 221 and is co-axial with the connector 221.

With the structure described above, when replacing the damaged protective unit 21, the person replacing it can adjust the distance between the protective units 21 by increasing or decreasing the number of limiting members 223 between adjacent units, as needed. Since the limiting member 223 is fitted onto the connector 221, when removing the connector 221, the limiting member 223 can easily be removed at the same time. Upon reinstallation, the limiting member 223 can be directly fitted onto the connector 221, avoiding the hassle of installing the limiting member 223 separately and offering more flexible spacing options.

In this embodiment, the protective unit 21 at the topmost position extends inward to form a hanging cover portion 23, which is used to connect to the through rod 3.

Through the above structure, the fan protective shell structure 2 is fixed to the through rod 3 via the hanging cover portion 23. Since the fan protective shell structure 2 is fixed to the through rod 3 via the hanging cover portion 23, compared to being fixed directly to the motor 1, the hanging cover portion 23 and the through rod 3, being a regular cylindrical shape, provide a more stable connection. This makes the fan protective shell structure 2 more stable. Additionally, by increasing the stability of the fan protective shell structure 2, the hanging cover portion 23, which extends inward from the topmost protective unit 21, covers the top of the motor 1. This prevents dust from falling into the motor 1 from above and provides protection for the motor 1's top.

In this embodiment, the fan protective shell structure 2 also includes a hanging base 24. The hanging base 24 includes a fixed portion 241, a connecting portion 242, and a second fastener 243. The hanging cover portion 23 is fixedly connected to the connecting portion 242 via the second fastener 243, and the fixed portion 241 is used to connect to the through rod 3.

With the above structure, the hanging cover portion 23 is fixed to the connecting portion 242 using the second fastener 243, and the fixed portion 241 connects to the through rod 3. When a replacement is needed, the hanging cover portion 23 can be removed by simply dismantling the hanging base 24, without needing to disassemble the through rod 3. Moreover, because of the clear distinction between the fixed portion 241 and the connecting portion 242, the person replacing the components can easily identify which part needs to be operated upon.

In this embodiment, the connecting portion 242 is provided with a first through hole 242a, and the hanging cover portion 23 is correspondingly provided with a second through hole 232a. The second fastener 243 is inserted into the first through hole 242a and the second through hole 232a.

With this structure, when the hanging cover portion 23 needs to be removed from the hanging base 24, the second fastener 243 can be taken out from the first through hole 242a and the second through hole 232a to complete the disassembly, making the operation more convenient. Additionally, because the first through hole 242a and the second through hole 232a are correspondingly positioned, the installation is simplified: the first through hole 242a and the second through hole 232a are aligned, and the second fastener 243 is inserted to complete the installation.

In this embodiment, the fan protective shell structure 2 further includes a snap-fit member 25 and a protective cover 26. The protective cover 26 is snap-fitted onto the snap-fit member 25, and the snap-fit member 25 is used to connect to the through rod 3. The protective cover 26 and the hanging cover portion 23 together form an accommodating space, within which the fixed portion 241 is located.

With this structure, the fixed portion 241 is within the accommodating space formed by the protective cover 26 and the hanging cover portion 23, preventing the fixed portion 241 from being damaged by external forces, which could risk the entire structure falling off. Additionally, the snap-fit member 25 connects the protective cover 26 to the through rod 3. When replacing the protective cover 26, the protective cover 26 can be simply removed from the snap-fit member 25 without disassembling the through rod, making it easy to replace the protective cover 26. The presence of the protective cover 26 also improves the overall visual effect of the ceiling fan, providing users with a better aesthetic while not affecting its functionality.

In this embodiment, the hanging cover portion 23 has a first linkage hole 231, and the protective cover 26 has a second linkage hole 261. The first linkage hole 231 and the second linkage hole 261 allow for the insertion of the through rod 3.

With this structure, the relative positions of the hanging cover portion 23 and the protective cover 26 are fixed. Under the effect of gravity, they will not easily detach, improving the safety of the structure. Furthermore, when the protective cover 26 or the hanging cover portion 23 needs to be disassembled, it is simple to remove by first taking out the fixing device and then detaching the protective cover 26 or hanging cover portion 23 along the first linkage hole 231 and second linkage hole 261.

This embodiment also discloses a ceiling fan, including a motor 1 and the fan protective shell structure 2 as described above. The fan protective shell structure 2 surrounds the motor 1, and the lower end of the fan body is additionally provided with a light 11. In this embodiment, when the fan protective shell structure 2 is damaged, the damaged protective unit 21 can be individually replaced. Moreover, appropriate spacing between each protective unit 21 can be maintained, allowing for cost reduction without affecting the protection effect.

As described above, one or more embodiments have been provided in conjunction with specific details, but the specific embodiments of this application are not limited to these descriptions. Any methods, structures, or other features that are similar or equivalent to those described in this application, or any technical deductions or modifications made based on the concepts of this application, should be considered within the scope of the protection of this application.

1. A fan protective shell structure, the fan protective shell structure surrounds the motor to provide protection for the motor, wherein it comprises:
a connecting assembly and at least three protective units, where each protective unit is detachably connected to the connecting assembly, and the protective units are spaced apart from each other.

2. The fan protective shell structure according to claim 1, wherein the connecting assembly comprises a connector, a first fastener, and each of the protective units is connected to the connector, with the first fastener securing the protective unit to the connector.

3. The fan protective shell structure according to claim 2, wherein the connecting assembly further comprises a limiting member, which is positioned between two adjacent protective units to define the distance between the adjacent protective units.

4. The fan protective shell structure according to claim 3, wherein each protective unit is provided with a connection hole, into which the connector is inserted, and the connector has a cavity running through both ends, and the first fastener is inserted into the cavity, with the end of the first fastener abutting the protective unit.

5. The fan protective shell structure according to claim 3, wherein at least one limiting member is provided between each pair of adjacent protective units, the limiting member is fitted onto the connector, and the limiting member is coaxial with the connector.

6. The fan protective shell structure according to claim 1, wherein the protective unit at the topmost position extends inward to form a hanging cover portion, which is used to connect to the through rod.

7. The fan protective shell structure according to claim 6, wherein the fan protective shell structure further comprises a hanging base, the hanging base comprises a fixed portion, a connecting portion, and a second fastener, with the hanging cover portion being fixedly connected to the connecting portion through the second fastener, and the fixed portion is used to connect to the through rod.

8. The fan protective shell structure according to claim 7, wherein the connecting portion is provided with a first through hole, and the hanging cover portion is correspondingly provided with a second through hole, with the second fastener being inserted into both the first through hole and the second through hole.

9. The fan protective shell structure according to claim 8, wherein the fan protective shell structure further comprises a snap-fit member and a protective cover; the protective cover is snap-fitted onto the snap-fit member, and the snap-fit member is used to connect to the through rod; the protective cover and the hanging cover portion form an accommodating space, within which the fixed portion is located.

10. The fan protective shell structure according to claim 9, wherein the hanging cover portion has a first linkage hole, and the protective cover has a second linkage hole, the first linkage hole and the second linkage hole are used to allow the through rod to be inserted.

11. A ceiling fan, wherein it comprises a motor and the fan protective shell structure according to claim 1, the fan protective shell structure surrounds the motor, and the lower end of the fan body further comprises a light.

12. The ceiling fan according to claim 11, wherein the connecting assembly comprised in the fan protective shell structure, comprises a connector, a first fastener, and each of the protective units is connected to the connector, with the first fastener securing the protective unit to the connector.

13. The ceiling fan according to claim 12, wherein the connecting assembly further comprises a limiting member, which is positioned between two adjacent protective units to define the distance between the adjacent protective units.

14. The ceiling fan according to claim 13, wherein each protective unit is provided with a connection hole, into which the connector is inserted, and the connector has a cavity running through both ends, and the first fastener is inserted into the cavity, with the end of the first fastener abutting the protective unit.

15. The ceiling fan according to claim 13, wherein at least one limiting member is provided between each pair of adjacent protective units, the limiting member is fitted onto the connector, and the limiting member is coaxial with the connector.

16. The ceiling fan according to claim 11, wherein the protective unit at the topmost position extends inward to form a hanging cover portion, which is used to connect to the through rod.

17. The ceiling fan according to claim 11, wherein the fan protective shell structure further comprises a hanging base, the hanging base comprises a fixed portion, a connecting portion, and a second fastener, with the hanging cover portion being fixedly connected to the connecting portion through the second fastener, and the fixed portion is used to connect to the through rod.

18. The ceiling fan according to claim 17, wherein the connecting portion is provided with a first through hole, and the hanging cover portion is correspondingly provided with a second through hole, with the second fastener being inserted into both the first through hole and the second through hole.

19. The ceiling fan according to claim 18, wherein the fan protective shell structure further comprises a snap-fit member and a protective cover; the protective cover is snap-fitted onto the snap-fit member, and the snap-fit member is used to connect to the through rod; the protective cover and the hanging cover portion form an accommodating space, within which the fixed portion is located.

20. The ceiling fan according to claim 19, wherein the hanging cover portion has a first linkage hole, and the protective cover has a second linkage hole, the first linkage hole and the second linkage hole are used to allow the through rod to be inserted.
